(19) United States
(12) Patent Application Publication
(10) Pub. No.: US 2010/0018142 A1
(43) Pub. Date: Jan. 28, 2010

(54) METHOD OF MANUFACTURING A FIRE RETARDANT COMPOSITE, A COMPOSITE AND ITS USE

(76) Inventors: Peter Willem Marie Schouren, Maastricht (NL); Eric Peter Wilhelmus Elisabeth Smeets, Sittard (NL); Moses Rathbun, Maastricht (NL); Abraham Araya, Wirral (GB); Henricus Johanna De Swart, Dongen (NL); Wilhelmus Petrus Theodorus Kemperman, Hapert (NL); Jan Noordegraaf, Wijchen (NL); Petrus Erederikus Maria Rensen, Doornenburg (NL); Christianus Marcus Gijsbertus Maria Buijk, Eindhoven (NL)

Correspondence Address: ROBERTS & ROBERTS, LLP;ATTORNEYS AT LAW, P.O. BOX 484, PRINCETON, NJ, 08542-0484, US

(21) Appl. No.: 12/523,831

(22) PCT Filed: Jan. 23, 2008
(86) PCT No.: PCT/NL08/00025

§ 371 Date: Oct. 1, 2009

(30) Foreign Application Priority Data
Jan. 23, 2007 (GB) 0701245.3
Jan. 23, 2007 (NL) 1033269

(51) Int. Cl. E04C 2/20; B29C 67/20; C09D 5/18; C08J 9/22

(52) U.S. Cl. 52/309.4; 264/123; 106/18.12; 521/57

(57) ABSTRACT

A method of manufacturing a fire retardant composite, a composite and its use. A method of manufacturing a fire retardant composite by applying an aqueous gel-forming composition, e.g. a fire retardant coating composition, on a substrate comprises an aluminosilicate, the aluminosilicate comprising alkali metal aluminate and an alkali metal silicate, and an organic liquid having a boiling point greater than 110° C., e.g. silicone oil. The molar ratio of SiO₂:X₂O for the alkali metal silicate is from 3.6:1 to 10:1, where X represents the alkali metal of the alkali metal silicate, when the alkali metal aluminate has a molar ratio of Y₂O:AI₂O₃ of 1.35:1, where Y represents the alkali metal of the alkali metal aluminate, this providing improved water resistance for films or coatings prepared from the compositions by drying and curing.

A method of manufacturing a fire retardant composite, a composite and its use.

The present invention relates to a method of manufacturing a fire retardant composite, a composite having a coating with fire retardant properties, as well as its use as a construction material.

Soluble silicates are widely used as adhesives, coatings and bondings. Whilst their inherent solubility is an asset in many of the applications for which they are used, it is disadvantageous for applications where, for example, water resistance, integrity and strength of structure are deemed essential.

Considerable efforts have been made to minimise the solubility of silicates in compositions of the kind referred to above, for example by addition of metal (such as calcium and magnesium) salts. However, addition of such salts tends to result in a precipitated form rather than a product with a continuous network-like structure. The soluble salt formed in the precipitation reaction is deleterious to the physical integrity of the applied film and hence ultimately, strength of the resultant product.

Factors such as these are a deterrent to the use of silicates in for example the production of fire retardant coating composition. Fire retardant coating compositions find wide application in the construction and building maintenance industries, for example for application to flammable building materials before, or after, their incorporation in a building structure. Examples of flammable materials are polymer tiling and sheeting, e.g. of expanded polystyrene or urethane plastics and composites containing such plastics. Wood, wood chip and paper based materials can also benefit from application of such coatings. Included within the class of fire retardant coating compositions are so-called intumescent coating which exert their protectant action partly by swelling when exposed to heat or fire.

In some cases, flammable materials are sold with the fire retardant coating pre-applied. For example, an intumescent fire retardant coating known as SafeCoat E84™ is pre-applied to expanded polystyrene/polyurethane foam articles prior to sale.

U.S. Pat. No. 5,462,699 relates to a fire retardant composition for application to, inter alia, building materials, the composition containing a silicate, water and surfactant.

PCT publications WO 2007/012832, WO 2007/013791 and WO 2007/012441, whose publication dates are later than the filing date of the present application, disclose aqueous gel-forming compositions, e.g. fire retardant coating compositions, comprising an aluminosilicate and an organic liquid having a boiling point greater than 110° C., e.g. silicone oil, which enhances the integrity of films formed by application of the composition as a coating to a surface then followed by drying. The only example of sodium silicate, used in the examples of these applications, has a molar ratio SiO₂:Na₂O of 3.3:1

The problem with using a silicate based fire retardant composition for building insulation materials such as expanded polystyrene (e.g. roofing insulation) is that, until needed, such materials are often left exposed to the adverse weather conditions after delivery to the building site, Unless precautions are taken to protect them against the wet, such exposure can result in significant loss of the fire retardancy properties of the silicate-based composition.

As disclosed in PCT publications WO 2007/012832, WO 2007/013791 and WO 2007/012441, it was found that improved aqueous coatings could be produced from aluminosilicates in such a way that the solubility problem discussed above was significantly counteracted thus making compositions suitable for use as fire retardant compositions. It has now been found that the compositions, as disclosed in PCT publications WO 2007/012832, WO 2007/013791 and WO 2007/012441, may be given improved water resistance by means of selection of specific alkali metal silicates for use in the preparation of the aluminosilicate.

As for PCT publications WO 2007/012832, WO 2007/013791 and WO 2007/012441, the present invention is not limited to aqueous compositions for fire retardancy use; other applications such as use of the composition as an adhesive or binder are within the ambit of the present invention. A further advantage of the compositions of the invention is that they may be used to prepare fire retardant systems that are substantially free of halogen-containing compounds. Halogen-containing compounds are undesirable because of their potential environmental risk.

Thus, the present invention provides a method of manufacturing a fire retardant composite by applying an aqueous gel-forming composition on beads of foamed polymer, comprising an aluminosilicate, comprising an alkali metal aluminate, preferably sodium aluminate and alkali metal silicate, and an organic liquid which enhances the integrity of films formed by application of the composition as a coating to a surface followed by drying.

The invention provides an aqueous gel-forming composition comprising:

(a) from 5% to 40% by weight of an aluminosilicate comprising alkali metal aluminate and alkali metal silicate,

(b) from 0.1% to 10% by weight of an organic liquid,

wherein the organic liquid has a boiling point of greater than 110° C., characterized in that the molar ratio of SiO₂:X₂O for the alkali metal silicate is from 3.6:1 to 10:1, wherein X represents the alkali metal of the alkali metal silicate and the alkali metal aluminate is expressed using a molar ratio of Y₂O:Al₂O₃ of 1.35:1, where Y represents the alkali metal of the alkali metal aluminate.

The present method comprises the following steps:

i) providing beads of foamed polymer,

ii) applying a coating on the beads of step i) and

iii) shaping the thus coated beads into said composite.

Preferred embodiments can be found in the appended subclaims. The foamed polymer is selected from PUR, PET, EPP, EPE, expanded polyvinyl arylenes or a combination thereof. Preferred embodiments of step iii) are a casting method and a pressing method. It is possible to carry out step ii) in a fluid bed, wherein the coating is sprayed on the beads and an air flow is blown through the bed of beads. In another embodiment it is preferred to carry out step ii) in an agitated bed, wherein the coating is sprayed onto the beads. Step ii) can also be carried out in a mixer, for example a ribbon blender, wherein the coating is sprayed on the beads, or step ii) is carried out by application means comprising roller means, brush means or a vessel for containing the coating into which products to be coated or impregnated can be immersed.

In one embodiment step iii) further comprises steps iv), v) and vi), in which step iv) transferring the coated beads to a press, v) applying steam to the coated beads present in said press, and vi) releasing the composite from the press. The coating composition is cured by heating at a temperature from 50-120° C. for a time from 30 minutes to 24 hours.

Boiling points in this specification are to be measured at standard atmospheric pressure.

By aqueous it is meant that the balance of the composition comprises water and optionally one or more other ingredients. Typically, the compositions of the invention comprise at least 20% by weight of water, preferably at least 30%, more preferably at least 40%.

As used herein, the term “gel” refers to a substance that contains a continuous solid skeleton (in the present invention based on the aluminosilicate) enclosing a continuous liquid phase (in the present case, predominantly water)—see for example Sol-Gel Science, The Physics and Chemistry of Sol-Gel Processing (C J Brinker and G W Scheer) published by Academic Press Inc., 1990, for example page 8. These materials may also be referred to as co-gels or coagels. Initially, the solid may be in the form of dispersed, discontinuous solid particles (a sol), but these individual particles coalesce to form a continuous solid network. The compositions of the invention are initially in the form of a sol which converts over time to a gel.

A preferred class of compositions according to the present invention consists of those which comprise:

(a) from 5% to 40%, preferably from 5 to 30%, more preferably from 10% to 25% by weight of the aluminosilicate comprising alkali metal aluminate and alkali metal silicate, characterized in that the molar ratio of SiO₂:X₂O for the alkali metal silicate is from 3.6:1 to 10:1, wherein X represents the alkali metal of the alkali metal silicate and the alkali metal aluminate is expressed using a molar ratio of Y₂O:Al₂O₃ of 1.35:1, where Y represents the alkali metal of the alkali metal aluminate;

(b) from 0.1% to 10%, preferably from 0.3% to 5% by weight of the organic liquid; and

(c) the balance being the water, optionally further including one or more other ingredients.

In the absence of the organic liquid, it was found that for a given drying temperature, the more extensive the drying (i.e. loss of water), the more prone a film coating produced using the aluminosilicate composition is to result in a weak and powdery coating in a relatively short time. When the organic liquid is present however, the integrity of the coating in terms of its strength and non-powdery nature is considerably improved.

Sodium silicates are generally commercially available in aqueous solution form, typically with up to 60% dissolved solids content, with SiO₂:Na₂O molar ratios, typically varying from 0.5:1 to 3.5:1. For use in the present invention, suitable SiO₂:X₂O ratios are from 3.6:1 to 10:1, preferably from 3.8:1 to 7:1, more preferably from 3.9:1 to 5:1, where X represents the alkali metal of the alkali metal silicate.

The selection of the molar ratio of SiO₂:X₂O described above, where X represents the alkali metal of the alkali metal silicate, leads to a surprising increase in the water resistance of the cured and dried or dried films formed from the aqueous compositions of the invention.

Preferably, the alkali metal X is sodium, potassium, lithium or a mixture thereof. More preferably, the alkali metal X is potassium or sodium or a mixture thereof. For reasons of ready availability, sodium may be preferred. However, if greater resistance to carbonate formation caused by reaction with atmospheric CO₂ is desired, the incorporation of potassium is preferred. If greater resistance to dissolution in water is desired, then the incorporation of lithium is preferred. Provided with this information, the skilled person may optimise the amounts of Li, K and Na to suit their requirements.

The alkali metal aluminate may be any suitable alkali metal aluminate, preferably Na, K or Li aluminate or mixtures thereof, more preferably Na or K aluminate or mixtures thereof, most preferably sodium aluminate. Sodium aluminate is commercially available as a solid with an Na₂O:Al₂O₃ molar ratio of 1:1, but is also available as concentrated aqueous solutions with Na₂O:Al₂O₃ molar ratios in the range 2.0:1 to 1:1. Suitably, the molar ratio Na₂O:Al₂O₃ in sodium aluminate for use in compositions systems and methods according to the present invention is from 1.6:1 to 1:1, preferably from 1.4:1 to 1:1. These ratios are also applicable to other alkali metal aluminates and combinations thereof, when used for compositions, systems and methods according to the invention. However, for the present invention, and in this description, alkali metal aluminate, as expressed in defining compositions of the invention, is to be interpreted as alkali metal aluminate with a molar ratio of Y₂O:Al₂O₃ of 1.35:1, for the sake of calculation, where Y represents the alkali metal of the alkali metal aluminate. This is necessary to prevent any ambiguity in the relative amounts of total alkali metal oxide (X₂O and Y₂O), Al₂O₃ and SiO₂ in the aluminosilicate of compositions of the invention. The separation of the alkali metal oxide into X₂O and Y₂O is merely for the convenience of calculating and defining the composition of the aluminosilicate, and in practice X and Y will each represent the same alkali metal, or alkali metal blend present in the aluminosilicate. The calculation is made as follows. The analysis is made to give amounts of Al₂O₃, X₂O and Y₂O. Then starting with the amount of Al₂O₃ in the composition, each mole of Al₂O₃ is paired with 1.35 moles of alkali metal oxide (Y₂O). The ratio of the remaining alkali metal oxide (X₂O) and the SiO₂ define the alkali metal silicate in the aluminosilicate of the composition.

Any reference herein to a liquid means a substance which is liquid, preferably pourable, at 25° C. at atmospheric pressure, unless explicitly stated to the contrary. Further, all viscosities stated herein which refer to non-Newtonian liquids or gels are viscosities measured at a shear rate of 23 s⁻¹ and at 25° C.

The organic liquid is preferably one which is substantially water-immiscible. Usually the degree of immiscibility is such that, at 25° C., the organic liquid dissolves to the extent of less than about 10% by weight (preferably less than about 5% by weight, more preferably less than 1% by weight) in water, or water dissolves to the extent of less than about 10% by weight (preferably less than about 5% by weight, more preferably less than 1% by weight) in the organic liquid.

Although the composition of the present invention can be applied as a fire retardant coating to a surface or substrate, it is not limited to this particular application and may, for example, be used as a binder or adhesive or a water-resistant coating, irrespective of whether the composition serves to confer fire retardancy in such other applications.

The aluminosilicate as used in the present invention is typically formed by the sol-gel route and this can be effected in situ by forming the aluminosilicate at the point of use, by mixing precursor liquids comprising alkali metal aluminate and alkali metal silicate. Thus, the present invention provides a precursor system for forming a coating composition according to the first aspect of the invention, the precursor system comprising:

(i) an alkali metal aluminate;

(ii) an aqueous solution of an alkali metal silicate; and

(iii) an organic liquid.

A sol-gel is basically a reaction product which is initially formed from the components of the precursor system as a liquid, but which subsequently forms a gel and ultimately solidifies. In order to form the gel-sol, either solid aluminate is admixed with an aqueous silicate solution or aqueous aluminate solution is admixed with an aqueous silicate solution.

At least part of the organic liquid may be incorporated in component (i) and/or component (ii). Alternatively, the organic liquid may initially be entirely separate from both of components (i) and (ii) and be admixed contemporaneously with, or subsequent to, the admixture of components (i) and (ii). Preferably, the organic liquid is incorporated into component (i) and/or (ii) prior to admixing the components to form the sol-gel system.

The invention further provides an aqueous solution of an alkali metal silicate and at least one organic liquid selected from the group consisting of polyhydroxy alcohols, mineral oils, liquid paraffin oils, glycol ethers, silicone oils and mixtures thereof, characterized in that the molar ratio of SiO₂:X₂O for the alkali metal silicate is from 3.6:1 to 10:1, preferably from 3.8:1 to 7:1, more preferably from 3.9:1 to 5:1, wherein X represents the alkali metal of the alkali metal silicate. This composition is suitable as a part of the precursor system as disclosed above.

The present invention provides an application system for forming a coating composition according to the invention from a precursor system according to the invention and applying the coating composition so formed to a substrate, the application system comprising means for admixture of components (i), (ii) and (iii) and application means for effecting coating of the substrate with the resulting mixture. The application system for forming a coating composition and applying the coating composition so formed to a substrate suitable comprises an alkali metal aluminate, preferably sodium aluminate, (i) stored in a first storage means, an aqueous solution of an alkali metal silicate (ii) in a second storage means and an organic liquid (iii) in a third storage means or in the first and/or second storage means, a means for admixture of components (i), (ii) and (iii) and application means for effecting coating of the substrate with the resulting mixture.

The organic liquid may be stored in its own, separate storage means, or may be admixed with either or both of the alkali metal aluminate or the aqueous solution of alkali metal aluminate in their respective storage means.

The alkali metal aluminate may be in the form of an aqueous solution. Suitable storage means are tanks, containers or vessels in fluid connection with the means for admixture of the components. The transport of the components to and from the means for admixture may be effected by an arrangement of pumps and valves to meter the dosage of each component to the admixture means.

The present invention provides a method of making a coating composition, the method comprising admixture of the following components:

(i) an alkali metal aluminate;

(ii) an aqueous solution of an alkali metal silicate; and

(iii) an organic liquid.

The following preferred features of the invention are applicable to all previously mentioned aspects of the invention where appropriate.

Coatings formed from compositions according to the present invention exhibit superior physical integrity and long term stability, in comparison with conventional silicate systems. Without wishing to be bound by any theory, it is thought that this improvement arises by virtue of the aluminosilicate being present in the form of a network of bonded molecules that extends throughout the solution and by virtue of the presence of said organic liquid.

Typically the composition of the first aspect of the invention prior to application to a surface or substrate comprises at least 5% by weight of the aluminosilicate, and at least 0.1% by weight of said organic liquid.

For the sake of clarity, the preferred values for ingredients detailed below apply to all aspects of the invention. However the values are expressed in terms of the composition of the invention. When applied, for instance, to the precursor system or the application system or the precursor compositions, the preferred values apply to the values achieved in the resulting sol-gel composition.

The amount of water in compositions of the invention is preferably from 60% to 95%, more preferably from 70% to 95%, especially from 75% to 90% by weight of the total composition. This is the value prior to drying or curing of the compositions. At lower moisture contents, the viscosity of the compositions may become too high to allow for ease of processing and too high to allow for even coating or spraying of the compositions onto surfaces.

The aluminosilicate is typically amorphous, which may be assessed by the absence of sharp peaks in the x-ray powder diffraction spectrum of the material. The mole ratio of Si:Al in the composition is typically from 3:1 to 30:1, preferably from 4:1 to 15:1 and more preferably from 5:1 to 10:1. In this context, the reference to mole ratio of Si:Al is based on the amount of silicon (in moles) in the silicate and aluminium (in moles) in the aluminate used for preparation of the compositions. The aluminosilicate is usually formed by the sol-gel route, preferably in situ from admixture of precursor components at the point of use.

Compositions according the present invention preferably also comprise a metal or metal oxide to inhibit water absorption and/or to aid preservation of the film forming properties of the composition, especially film integrity, upon storage. The metal or oxide will usually be in particulate form and be sparingly soluble in water. Suitably the volume median particle diameter of the metal or metal oxide will be 50 μm or less. Preferably, less than 1% by volume of the metal or metal oxide particles will exceed 200 μm. Amphoteric or acidic oxides are typically employed for this purpose.

As used herein, the term “acidic oxide” means an oxide which reacts with either an alkali or base to form a salt plus water.

The term “amphoteric oxide” means an oxide which can display either acidic or basic character depending on the reactant which is reacted with it and/or upon the reaction conditions.

The metal oxide may, for example, be selected from amphoteric oxides of Group III elements, preferably boron and gallium oxides, or zinc oxide and mixtures thereof. Alternatively, the metal oxide may for example be selected from acidic oxides of Group IV elements, preferably tin oxides and germanium oxides, or zirconium oxide and mixtures thereof. Mixtures of one or more amphoteric oxides with one or more acidic oxides may also be used. Instead of introducing the metal in the form of an oxide, the oxide may alternatively be formed in situ as a result of adding the metal per se to the composition. Without wishing to be bound by theory, it is believed that the zinc or other metal oxide reacts with any residual silicate to reduce solubility of films formed by coating or otherwise applying the composition to substrates.

Preferably, the amount of the metal oxide or metal is 0.1% to 10%, preferably from 0.3% to 5% by weight (e.g. from 0.3% to 3% by weight) of the total composition prior to drying or curing.

Compositions according to the invention preferably comprise from 0.1% to 10%, preferably from 0.3% to 5% (e.g. 0.3% to 4%) by weight of the organic liquid prior to drying or curing.

Suitably, the organic liquid has a boiling point (at atmospheric pressure) greater than 110° C. Preferably, the organic liquid has a boiling point (at atmospheric pressure) of at least about 120° C., typically at least about 130° C. and typically up to about 500° C. Preferably the boiling point is no more than 500° C., preferably no more than 300° C.

The organic liquid is desirably one which is stable under alkaline conditions, by which is meant that it can withstand storage in an aqueous composition of pH 9 or more, preferably pH 12 or more without significant chemical degradation (i.e. less than 1% loss by weight of the liquid by degradation at 25° C. for 30 days storage) and also stable with respect to oxidation, heat and light.

The organic liquid is typically one having a viscosity of less than 5000 mPa·s, preferably less than 2000 mPa·s (e.g. less than 1000 mPa·s), at a temperature of 25° C. measured at a shear rate of 23 sec⁻¹.

The organic liquid may comprise one or more substantially water immiscible organic solvents selected from polyhydroxy alcohols, mineral oils, liquid paraffin oils, glycol ethers, silicone oils and mixtures thereof. Of these, silicone oils are especially preferred. It is preferred if the organic liquid is a silicone oil.

Suitable silicone oils for use in compositions according to the present invention and precursor systems therefore, are organosiloxanes, typically having the general formula (I):

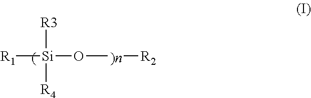

wherein n is the number of repeating units in the polymer and can range from 2, e.g. from 10, up to 1,000,000, more preferably from 30, e.g. from 50, up to 500,000 and can be selected from hydrogen or methyl groups and R₂ can be selected from hydrogen or SiR₅ in which R₅ can be either hydrogen, hydroxyl or methyl and wherein R₃ and R₄ can be independently selected from C₁ to C₁₂ straight chain or branched, saturated or unsaturated alkyl, alkenyl or phenyl moieties or from units according to formula (I) above or from substituted alkyl or substituted phenyl moieties in which substituents can be halogens, amino groups, sulphate groups, sulphonate groups, carboxy groups, hydroxy groups or nitro groups. Preferably, R₃ and R₄ are methyl groups. Preferably the silicone oils for use in the invention are free from halogen substituents.

One or more optional other ingredients may beneficially be incorporated in compositions according to any aspect of the present invention, e.g. in amounts from 0.001% to 5%, such as 0.01% to 2% by weight of the composition for any or each class, and may for example be selected from any of the classes:—

(i) one or more surfactants, preferably selected from anionic, nonionic, cationic, amphoteric and zwitterionic surfactants and mixtures thereof, for example those which are known to be compatible with silicate and/or aluminate solutions, such as alkali capryloamphopropionates (e.g. Crodateric CyNa50);

(ii) one or more phosphonates and/or phosphonic acids, such as tri-phenylphosphates and nitrilotric (methylene) triphosphoric acid;

(iii) one or more slow proton releasing inorganic salts such as dihydrogen aluminium phosphates;

(iv) one or more sequestrants such as EDTA or of the phosphonate type, e.g. those sold under the name Dequest; and

(v) one or more isocyanates such as methylene di-isocyanate.

Compositions according to the present invention (which may optionally be prepared from a precursor system at the point of use) may for example be applied to the substrate by means of a spray gun (optionally air or gas pressurised), a roller system or a brush system. Alternatively the material to be treated may be coated or impregnated by immersion of the material in the coating composition while the coating composition is contained in a suitable vessel.

Compositions according to the present invention which are to be used as fire retardants may be applied to any appropriate flammable substrate but are especially suited to those which comprise an expanded or foamed polymer. Most preferably, that polymer is one which is substantially insoluble in the organic liquid at room temperature, i.e. the liquid component is selected with that requirement in mind.

Depending on the intended function of the cured composition, the composition may instead be applied to a substrate comprising one or more substances selected from wood, non-foamed polymer, metal, glass, ceramic, concrete, composite building material such as breezeblock, tile or brickwork, paper or china, or other vitreous ware.

When the composition of the invention is used to prepare fire retardant systems, it is preferred if the resulting system is substantially free of halogen-containing compounds, i.e. containing less than 1% by weight, preferably less than 0.5% by weight of such compounds.

Preferably, the moisture content of the resultant cured and dried composition film (i.e. the final film or coating, ready for use) is no greater than 40%, more preferably no greater than 30%, still more preferably no greater than 25% and yet more preferably no greater than 20% by weight. Even more preferably, the moisture content of the dried composition is 17% by weight or less.

The water resistance properties of the film/coating resulting from the compositions of the invention may be improved by holding the composition in an environment at a temperature from 50 to 120° C., preferably from 60 to 110° C., more preferably from 70 to 100° C., i.e. curing the composition. Suitably, the composition is held in this environment for a time from 60 minutes to 24 hours, preferably from 90 minutes to 18 hours, more preferably from 2 hours to 14 hours, to ensure that the composition's temperature reaches that of the environment. Preferably, the composition has a moisture content during curing from 20% to 50% by weight. The moisture content is preferably maintained during curing by carrying out the curing in a high humidity (e.g. 100% rh) atmosphere or by means of heating in a hermetically sealed environment to minimise moisture loss. After curing, the composition may dried, to further improve resistance to dissolution, preferably to a moisture content of 17% by weight or less.

In order to achieve the preferred moisture content of 20 to 50% during curing, it may be preferable to dry the composition of the invention prior to curing, but after coating, particularly if the composition has its preferred initial moisture content for processing and coating of from 70% to 90% by weight.

Alternatively, the processes of curing and drying may be combined by heating the composition in an environment where moisture is lost gradually.

In addition, the properties of the film, such as hydrophobicity or lubricity, may be enhanced by applying onto the film a low melting point wax, such as for example micronized polyethylene wax (a low molecular weight polyethylene polymer that is oxidized or non-oxidized and because of its low molecular weight has wax-like physical characteristics) or a stearate, such as glycol stearate (for example glycol tristearate) or a metal stearate (for example Zn, Ca, Na, Mg Stearate) or a combination of one or more waxes and one or more stearates. The wax, stearate or mixture thereof should preferably have a melting point from 60° C. to 150° C., more preferably from 80° C. to 135° C. and most preferably from 90° C. to 130° C. For example zinc stearate, with a melting point of 120-130° C. can be applied onto the film to serve as a lubrication agent to facilitate further processing of the coated film when applied to a polymeric material.

Preferred coatings have a long term solubility of no greater than 25%, typically no greater than 20%, preferably no greater than 15%, and more preferably no greater than 10%, as determined by the water resistance/solubility methodology defined hereinafter, after oven drying the film or coating at 80° C. in a ventilated oven to a water content of about 17% and then soaking in water at a temperature of about 22° C. for 7 days.

Another aspect of the invention provides a method of coating, impregnating or otherwise applying to a substrate, the method comprising coating, impregnating or applying to said substrate, a composition according to the present invention.

The present invention will now be explained in more detail by way of the following non-limiting examples.

### EXAMPLES

### Water Resistance/Solubility Methodology

In order to test water resistance/solubility, the following procedure was adopted:

The aluminosilicate composition was applied onto a foamed polymer as detailed in the examples below. 5.5 g of the coated foamed polymer was placed in a Sterelin™ jar and 100 g of demineralised water was added. The coated foamed polymers were fully submerged in the water (held in place to keep them submerged and to prevent floating) and left to stand at ambient temperature (22° C.). The contents of the solution were analyzed after storage for a set period of time (using titration) and the percentage solubility of the coating was determined using the following formula:

Dissolved Contents in the Solution×100
5.5

Analysis of Moisture Content

The moisture content is measured by loss on calcining. This is determined by the decrease of weight after heating a finely divided sample for at least 1 hour in an oven at a temperature of 800° C. Due to the presence of the organic liquid in the samples, the weight loss must be corrected to allow for the loss in weight due to calcination of the organic liquid. The correction factor is derived by calcining a sample of the organic liquid and measuring its weight loss and the amount of ash remaining. As the organic content of the composition is known, the moisture loss on calcining the composition can be easily derived.

Where the composition has been coated onto expanded polystyrene beads, the beads are first removed from the coating composition (by peeling) prior to calcination, such that there is no interference from the expanded polystyrene beads in the moisture measurement.

Simple experimentation using ovens and fluidized beds can be used to determine the required drying times and temperatures needed to arrive at the final desired moisture contents for the dried and cured films.

### Example 1

### Comparative

Batch Process (Al:Si Mole Ratio= 1:10)—not Cured

The following raw materials were mixed at 600-700 RPM with a propeller stirrer for about 15 minutes:

350 grams of sodium silicate solution (SiO₂:Na₂O=3.4) with a sodium silicate content of 35% and 3.5 grams of silicone oil (polydimethylsiloxane) with a viscosity of 350 mPa·s.

Sodium aluminate solution was prepared by mixing at 600 RPM for 10 minutes: 31.7 g of concentrated sodium aluminate solution (46.7% sodium aluminate) with 153 g of demineralised water. For this example and for all the subsequent examples, the ratio of Na₂O:Al₂O₃ was 1.35:1 for the sodium aluminate solution.

At a mixing speed of 16,000 RPM using an ultra-turrax mixer head (rotor/stator) the diluted sodium aluminate solution was added over a period of 2 minutes via a dosing pump into the diluted sodium silicate solution in a vessel, followed by further homogenisation for 1 minute. The mixture (now a sodium aluminosilicate sol) has a total sodium aluminosilicate content of 27% by weight. The mixture was then coated onto the expanded polystyrene beads by spraying onto the beads in a fluidized bed at 50° C. The coated beads were then dried in the fluidized bed to a moisture content of 12.5% by weight. Then the beads were returned to ambient temperature (22° C.) and stored immersed in water for 3 or 8 days prior to solubility measurement according to the method described above.

TABLE 1
Solubility of cured coating Example 1.

| | Solubility results | Solubility results |
|---|---|---|
| Moisture content | 3 days | 8 days |
| 12.5% | 14% | 32% |

### Example 2

### Batch Process (Al:Si Molar Ratio= 1:10)—Cured

The composition was as for Example 1 but with 83.7 g of aqueous SiO₂ gel (Lucilite™ PC5 available form Ineos Silicas Limited) added to the aluminate immediately prior to adding the silicate (with a silica content of 34.5% by weight) such that the SiO₂:Na₂O molar ratio was 4.5:1 based on the silicate solution. A further 10.4 g of sodium aluminate was also used to maintain an overall Al:Si molar ratio of 1:10.

This mixture was coated onto the expanded polystyrene beads by spraying onto the beads in a fluidized bed at 50° C. and subsequently dried in the fluidized bed to a moisture content of 35% by weight. Then the coated beads were cured for 4 hours at 85° C. in an oven sealed to prevent moisture loss. After curing the coated beads were dried in a ventilated oven at 85° C. to a moisture content of 12% by weight. The coated beads were stored immersed in water at ambient temperature for 7 and 18 days prior to solubility measurement using the method described above.

TABLE 2
Solubility of cured coating Example 2

| | Solubility results | Solubility results |
|---|---|---|
| Moisture content | 7 days | 18 days |
| 12% | 2.8% | 7.7% |

### Example 3

### Batch Process (Al:Si Molar Ratio=1:10)—not Cured

This example is as for example 1 but with a sodium silicate having a molar ratio SiO₂:Na₂O of 4.50 and with a silicate content of 27% by weight.

The following raw materials were mixed at 600-700 RPM with a propeller stirrer for about 15 minutes:

350 grams of the silicate solution and 3.5 grams of silicone oil (polydimethylsiloxane) with a viscosity of 350 mPa·s. A diluted sodium aluminate solution was prepared by mixing at 600 RPM for 10 minutes: 27.2 g of sodium aluminate solution with a concentration of 45.6% by weight of aluminate with 78 g of demineralised water.

Next the mixing equipment was replaced by an ultra turrax dispersing element (rotor/stator principal). At a mixing speed of 16,000 RPM the diluted sodium aluminate solution was added over a period of 2 minutes via a dosing pump into the diluted sodium silicate solution. The mixture was stirred at that mixing speed for a further 1 minute after addition had been completed. The mixture (now a sodium aluminosilicate sol) had a total sodium aluminosilicate content of 25%. Next, this mixture was coated onto the expanded polystyrene beads by spraying into a fluidized bed at 50° C. followed by drying in the bed to a moisture content of 12% by weight. Then the beads were returned to ambient temperature (22° C.). Solubility was measured according to the method described above after immersed storage for 8 and for 16 days.

TABLE 3
Solubility for Example 3

| | Solubility results | Solubility results |
|---|---|---|
| Moisture content | 8 days | 16 days |
| 12% | 11% | 20% |

### Example 4

### Batch Process (Al:Si Molar Ratio=1:10)—Cured, ZnO Added

This is as for example 3 but with zinc oxide added to the composition. The zinc oxide content of the final sodium aluminosilicate composition prior to drying/curing was 0.48%. Zinc oxide was added to the silicate solution prior to mixing with the aluminate solution.

This mixture was coated onto the expanded polystyrene beads by spraying onto the beads in a fluidized bed at 50° C. followed by drying in the same bed to a moisture content of 35% by weight. Then the coated beads were cured for 4 hours at a temperature of 85° C. in an oven sealed to prevent moisture loss. After curing the coated beads were dried in a ventilated oven at 85° C. to a moisture content of 12% by weight. Then the beads were returned to ambient temperature (22° C.). Solubility after immersion for 8 and 16 days was measured using the method described above.

TABLE 6
Solubility Example 4

| | Solubility results | Solubility results |
|---|---|---|
| Moisture content | 8 days | 16 days |
| 12% | 4.0% | 6.5% |

### Example 5

### In-Line (Continuous) Process (Al:Si Molar Ratio=1:10)—not Cured

The composition in this example is exactly the same as for example 3, but the composition was prepared by simultaneous pumping of: i) a solution of sodium silicate containing the silicone oil and ii) sodium aluminate solution—as two separate feeds into a high shear in-line mixer at the appropriate rates to achieve the same formulation as for example 3. The only difference with example 3 was that the mixture had a total sodium aluminosilicate content of 16% instead of 25%. This was achieved by addition of the required amount of water in equal amounts to the silicate and aluminate solution. A clear aluminosilicate sol was formed and a sample of this sol was treated and characterised in the same way as in Example 1.

The mixture was coated onto the expanded polystyrene beads by spraying into a fluidized bed at 50° C. and the coating was subsequently dried in the same bed to a moisture content of 12% by weight. No separate curing stage was carried out. Then the beads were returned to ambient temperature (22° C.) and solubility after immersion for 7, 14 and 20 days was measured using the method described above.

TABLE 5
Solubility Example 5

| Moisture | Solubility results | Solubility results | Solubility results |
|---|---|---|---|
| content | 7 days | 14 days | 20 days |
| 12% | 11% | 11% | 11% |

Example 1 is a comparative example and examples 2 to 5 are examples according to the invention. All of examples 2 to 5 give greater resistance to dissolution on storage than example 1.

1. A method of manufacturing a lire retardant composite, the method comprising the following steps: i) providing beads of foamed polymer, ii) applying a coating on the beads of step i) and iii) shaping the thus coated beads into said composite; wherein the coating as applied in step ii) is an aqueous gel-forming composition, comprising:
(a) from 5% to 40% by weight of an aluminosilicate comprising alkali metal aluminate and alkali metal silicate having the formula SiO₂:X₂O,
(b) from 0.1% to 10% by weight of an organic liquid,
wherein the organic liquid has a boiling point of greater than 110° C., wherein the molar ratio of SiO₂:X₂O for the alkali metal silicate is from
3.6:1 to 10:1, wherein X represents the alkali metal of the alkali metal silicate and the alkali metal aluminate is expressed using a molar ratio of Y₂O:Al₂O₃ of 1.35:1, where Y represents the alkali metal of the alkali metal aluminate.

2. (canceled)

3. (canceled)

4. The method according to claim 1, in which step ii) is carried out in a fluid bed, wherein the coating is sprayed on the beads and an air flow is blown through the bed of beads.

5. The method according to claim 1, in which step ii) is carried out in an agitated bed, wherein the coating is sprayed onto the beads.

6. The method according to claim 1, in which step ii) is carried out in a mixer, wherein the coating is sprayed on the beads.

7. The method according to claim 2, in which step iii) comprises further steps iv), v) and vi), in which step iv) transferring the coated beads to a press, v) applying steam to the coated beads present in said press, and vi) releasing the composite from the press.

8. The method as claimed in claim 1 in which the foamed polymer is selected from PUR, PET, EPP, EPE, expanded polyvinyl arylenes or a combination thereof.

9. The A method as claimed in claim 1 in which step ii) is carried out by application means comprising roller means, brush means or a vessel for containing the coating into which products to be coated or impregnated can be immersed.

10. (canceled)

11. The method according to claim 1 wherein the composition comprises from 5% to 30% by weight of the aluminosilicate.

12. (canceled)

13. The method according to claim 1 wherein the organic liquid has a boiling point of no more than 500° C.

14. The method according to claim 1 in which the organic liquid is substantially water immiscible.

15. The method according to claim 1 in which the organic liquid is stable under alkaline conditions.

16. The method according to claim 1 in which the organic liquid has a viscosity of less than 5,000 mPa·s at a temperature of 25° C.

17. The method according to claim 1 in which the organic liquid comprises a liquid selected from mineral oils, liquid paraffin oils, silicone oils and mixtures thereof.

18. The method according to claim 1 in which the organic liquid comprises a liquid selected from polyhydroxy alcohols, glycol ethers and mixtures thereof.

19. The method according to claim 1 wherein the organic liquid comprises a silicone oil.

20. The method according to claim 1 wherein the composition further comprises at least one metal or metal oxide.

21. (canceled)

22. The method according to claim 20, wherein the at least one metal or metal oxide comprises an amphoteric oxide selected from amphoteric oxides of Group III elements, and mixtures thereof.

23. The method according to claim 20 in which the metal oxide comprises an acidic oxide.

24. The method according to claim 23, wherein the acidic oxide is selected from acidic oxides of Group IV elements, and mixtures thereof.

25. The method according claim 20 the composition comprising up to 10% by weight of the metal or metal oxide.

26. The method according to claim 25 in which the aluminosilicate has a Si:Al mole ratio from 3:1 to 30:1.

27. The method according to claim 1 wherein the alkali metals X and Y are sodium, potassium, lithium or a mixture thereof.

28. (canceled)

29. A precursor composition comprising an aqueous solution of an alkali metal silicate having the formula SiO₂:X₂O, and at least one organic liquid selected from the group consisting of polyhydroxy alcohols, mineral oils, liquid paraffin oils, glycol ethers, silicone oils and mixtures thereof, wherein the molar ratio of SiO₂:X₂O for the alkali metal silicate is from 3.6:1 to 10:1, wherein X represents the alkali metal, and wherein X is sodium, potassium, lithium or a mixture thereof.

30. A precursor system for forming a coating composition the precursor system comprising:
(i) an alkali metal aluminate;
(ii) an aqueous solution of an alkali metal silicate; and
(iii) an organic liquid.

31. The method as claimed in claim 1 in which the foamed polymer as applied in step i) has a density of 5-500 kg/m³.

32. The method as claimed in claim 1 in which the foamed polymer as applied in step i) including the coating has a density of 10-1000 kg/m³, on a dried coating basis.

33. A composite of a foamed polymer having a coating with fire retardant properties, wherein the coating comprises an aqueous gel-forming composition, comprising:
(a) from 5% to 40% by weight of an aluminosilicate comprising alkali metal aluminate and alkali metal silicate having the formula SiO₂:X₂O,
(b) from 0.1% to 10% by weight of an organic liquid,
wherein the organic liquid has a boiling point of greater than 110° C., wherein the molar ratio of SiO₂:X₂O for the alkali metal silicate is from
3.6:1 to 10:1, wherein X represents the alkali metal of the alkali metal silicate and the alkali metal aluminate is expressed using a molar ratio of Y₂O:Al₂O₃ of 1.35:1, where Y represents the alkali metal of the alkali metal aluminate.

34. The composite according to claim 33, in which the moisture content of the dried or cured and dried composition is no greater than 40% by weight.

35. (canceled)

36. The composite according to claim 33, in which the aqueous gel forming composition further comprises a film-integrity enhancing organic liquid.

37. The composite according to claim 33 in which the aluminosilicate composition is from 45% to 90% by weight, on basis of the dried coating.

38. The composite according to claim 37, in which the aluminosilicate composition is from 50% to 85%, by weight, on basis of the dried coating.

39. The composite as claimed in claim 34, in which the dried coating has a moisture content no greater than 35.

40. The composite as claimed in claim 33 in which the coating further comprises at least one metal or metal oxide in an amount of up to 16% by weight of the dried coating.

41. The composite as claimed in claim 36 in which the organic liquid comprises up to 16% by weight of the dried coating.

42. A construction material comprising the composite according to claim 33 which is in the form of a panel, door sheeting, ceiling or tile, and which is part of a building.

43. (canceled)

44. The composite according claim 33 which is an insulant and which is part of a building.

45. (canceled)

46. (canceled)

47. The composite according to claim 33 which is in the form of a construction material for packaging.
